(19) United States
(12) Patent Application Publication
(10) Pub. No.: US 2014/0083609 A1
(43) Pub. Date: Mar. 27, 2014

(54) METHOD AND APPARATUS FOR EVACUATION OF LARGE COMPOSITE STRUCTURES

(71) Applicant: GENERAL ELECTRIC COMPANY, Schenectady, NY (US)

(72) Inventors: Howard Daniel DRIVER, Greer, SC (US); Amir RIAHI, Greenville, SC (US)

(73) Assignee: GENERAL ELECTRIC COMPANY, Schenectady, NY (US)

(21) Appl. No.: 13/628,894

(22) Filed: Sep. 27, 2012

(51) Int. Cl. B32B 37/10

(52) U.S. Cl. 156/285

(57) ABSTRACT

A method of making a compacted composite material preform including providing a pre-impregnated preform comprising a plurality of reinforcing fibers and a polymer matrix and positioning the preform on a base plate. The method includes enclosing the preform inside a vacuum bag defining a first cavity and enclosing the preform and vacuum bag inside a substantially rigid cover defining a second cavity. The method includes drawing a vacuum in the first cavity and the second cavity that is substantially equal or greater than the vacuum in the first cavity to remove air and volatiles from the preform. The method includes drawing a greater vacuum in the first cavity relative to the second cavity to urge the vacuum bag into compressive contact with the plurality of reinforcing fibers and the polymer matrix to a compacted arrangement.

### FIELD OF THE INVENTION

The present invention relates generally to processing composite material preforms, and more particularly to compacting pre-impregnated composite material preforms prior to curing the compacted composite material preforms.

### BACKGROUND OF THE INVENTION

Composite materials are increasingly being used for the manufacture of a variety of products because of their high strength and durability along with the ability to be formed into a variety of shapes. A longstanding problem for the processing of composite materials is that they are most commonly processed using a vacuum bag. Decades ago this was thought to be an ideal solution because one process (vacuum) would provide two desired effects on the laminated preform, to pull air and volatiles from the laminate while also providing ambient pressure to consolidate the laminate. Augmentation of pressure by autoclave is used routinely for smaller components but is not practical for large parts, for example, boat hulls and wind turbine blades. Resin systems have been developed that enable the curing of pre-impregnated materials without the use of autoclaves specifically to solve the large part problem (boats and wind turbine blades). A single vacuum bag is typically used for curing these systems; however, the resulting void content in the composite is usually too high, which can negatively affect strength and other properties of the composite. The single vacuum bag technique is not considered the most ideal way to make very low void content composite components without the use of an autoclave. The pressure that is applied to the preform inside the vacuum bag actually hinders the removal of bubbles by trapping the bubbles containing air and/or volatiles between the tacky layers of fiber and resin.

One known way to overcome this problem is to use multiple vacuum bags to obviate the need for a large expensive vacuum chamber. U.S. Pat. No. 7,413,694 B2 describes a vacuum bag within a vacuum bag to form an inner and outer chamber. The respective pressures in the inner and outer chambers are regulated to facilitate resin infusion into a dry fibrous preform. The level of independence achievable by this method is limited and not sufficient for pre-impregnated forms of composites. Another patent, U.S. Pat. No. 7,186,367, also describes a double vacuum bag approach. In this approach, the outer bag is constrained by an added rigid component, positioned between the inner and outer vacuum bags, from applying any pressure to the preform while the preform is under a vacuum. Another patent, U.S. Pat. No. 7,935,200 describes a protocol for determining process parameters for debulking composite laminates using a double vacuum debulk process.

However, in addition to previously mentioned limitations, the same apparatus for receiving composite material preforms and the manufacturing methods disclosed in each of the above-mentioned patents further utilize a combination of heat and pressure sufficient to cure the composite material, resulting in the completed composite article that is permanently sized and shaped to conform to the mold or base plate used. In a manufacturing facility in which large composite parts (up to and even exceeding 70 meters in length), such as wind turbine blades are fabricated, operations could be conducted with significantly less expense if a central processing area could be utilized, in which pre-impregnated composite material preforms could be compacted prior to curing, such that an uncured, compacted preform could be transported to and placed on one of a multiple of molds, from which different composite parts could be fabricated from the same compacted preform. Further, by having already compacted the preform prior to reaching the mold in which curing occurs, the molding process itself would be greatly simplified with a significant reduction in the amount of time required to provide a cured (completed) composite article.

Therefore, a method for producing uncured, compacted preforms that do not suffer from one or more of the above drawbacks would be desirable in the art.

### BRIEF DESCRIPTION OF THE INVENTION

According to an exemplary embodiment, a method of making a compacted composite material preform includes providing a pre-impregnated preform comprising a plurality of reinforcing fibers and a polymer matrix and positioning the preform on a base plate. The method includes enclosing the preform inside a vacuum bag defining a first cavity and enclosing the preform and vacuum bag inside a substantially rigid cover defining a second cavity. The method includes drawing a vacuum in the first cavity and drawing a vacuum in the second cavity that is substantially equal or greater than the vacuum in the first cavity to remove air and volatiles from the preform. The method then includes drawing a greater vacuum in the first cavity relative to the second cavity to urge the vacuum bag into compressive contact with the plurality of reinforcing fibers and the polymer matrix to a compacted arrangement.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a side elevation schematic illustration of an exemplary configuration of a wind turbine.

FIG. 2 is a front view of a wind turbine rotor blade.

FIG. 3 is a sectional illustration of an apparatus for processing a pre-impregnated preform in accordance with one embodiment.

FIG. 4 is a flow chart of a method of making a composite material preform.

Wherever possible, the same reference numbers will be used throughout the drawings to represent the same parts.

### DETAILED DESCRIPTION OF THE INVENTION

An apparatus and method of making composite material articles is described below in detail. The apparatus and method is described in reference to a wind turbine blade, but can be applicable to any composite article. The method utilizes a vacuum bag to provide a first vacuum cavity, and a substantially rigid cover overlying the first vacuum cavity to provide a second vacuum cavity that can be independently controlled relative to the first vacuum cavity. In addition, the method provides for pressures higher than the pressure provided by known vacuum bag processes, which is limited to about 15 pounds per square inch (psi). Utilizing a rigid cover permits operation in the range of known vacuum bag processes of greater than about 0 psi to about 15 psi. An advantage of higher processing vacuum pressure is that the higher vacuum pressure will result in faster and more complete evacuation of air from between the laminated layers of the preform. The pre-impregnated preform materials are typically B-staged (partially cured) into a state of very high viscosity and very low flow of the polymer matrix of the preform. However, for purposes of this disclosure, the term “cure” or variations thereof is intended to mean that the composite material cannot be flexed without risk of structurally damaging the resultant composite article, or reducing the strength properties of the composite part. Stated another way, composite material is still considered a preform, or compacted preform after being subjected to the method of the present disclosure for providing a compacted preform, the compacted preform being capable of being subjected to an amount of flexure in a mold without a significant amount of reduction of strength properties of the resultant cured composite article. The compacted preform is therefore considered to still be in a “pre-cured” or prior to curing” or similarly worded state or condition. With a known vacuum bag pressure only process, hold time to wait for the flow of polymer matrix may be reduced. A higher vacuum pressure provided by the substantially rigid cover can facilitate shortening of the hold time of the preform.

Although heat can be used to quicken the flow, heat will also advance the cure of the polymer matrix, which is not desired at this point in the fabricating process. The goal is to compact the preform without advancing the cure. The compacted preform is then moved to a shaped mold for final shaping and curing inside a vacuum bag. This molding step is where trapped air and gas is typically removed from the wind turbine blade being formed, but not very effectively. Utilizing the apparatus and method of processing the preform, described more completely below, provides for substantially complete removal of voids prior to molding and curing to the final blade geometry. This void reduction drastically reduces the time required in the expensive mold of final geometry. Therefore, process cycle time is improved and fabricating capacity is increased.

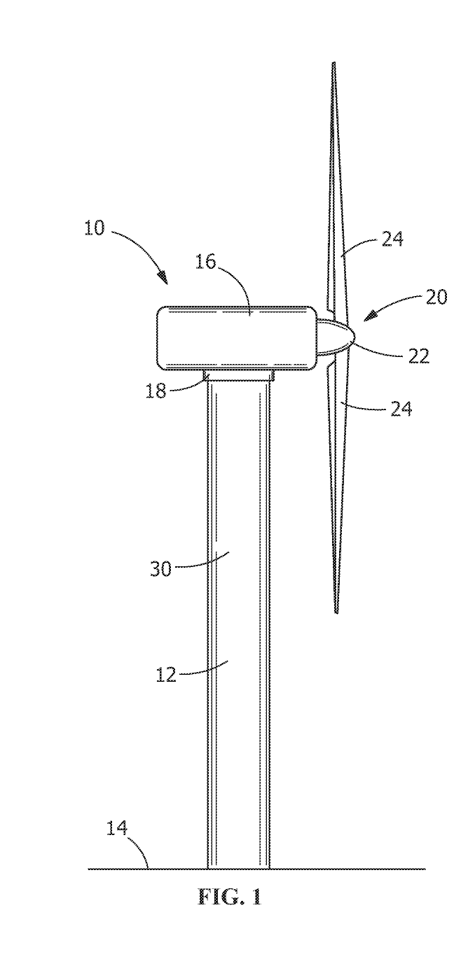

Referring to the drawings, FIG. 1 is a side elevation schematic illustration of a wind turbine 10, such as, for example, a horizontal axis wind turbine. Wind turbine 10 includes a tower 12 extending from a supporting surface 14, a nacelle 16 mounted on a bedframe 18 of tower 12, and a rotor 20 coupled to nacelle 16. Rotor 20 includes a hub 22 and a plurality of rotor blades 24 coupled to hub 22. In the exemplary embodiment, rotor 20 includes three rotor blades 24. In an alternative embodiment, rotor 20 includes more or less than three rotor blades 24. In the exemplary embodiment, tower 12 is fabricated from tubular steel and includes a cavity 30 extending between supporting surface 14 and nacelle 16. In an alternate embodiment, tower 12 is a lattice tower.

Various components of wind turbine 10, in the exemplary embodiment, are housed in nacelle 16 on top tower 12 of wind turbine 10. The height of tower 12 is selected based upon factors and conditions known in the art. In some configurations, one or more microcontrollers in a control system are used for overall system monitoring and control including pitch and speed regulation, high-speed shaft and yaw brake application, yaw and pump motor application and fault monitoring. Alternative distributed or centralized control architectures are used in alternate embodiments of wind turbine 10. In the exemplary embodiment, the pitches of blades 24 are controlled individually. Hub 22 and blades 24 together form wind turbine rotor 20. Rotation of rotor 20 causes a generator to produce electrical power.

In use, blades 24 are positioned about rotor hub 22 to facilitate rotating rotor 20 to transfer kinetic energy from the wind into usable mechanical energy. As the wind strikes blades 24, and as blades 24 are rotated and subjected to centrifugal forces, blades 24 are subjected to various bending moments. As such, blades 24 deflect and/or rotate from a neutral, or non-deflected, position to a deflected position. Moreover, a pitch angle of blades 24 can be changed by a pitching mechanism to facilitate increasing or decreasing blade 24 speed, and to facilitate reducing tower 12 strike.

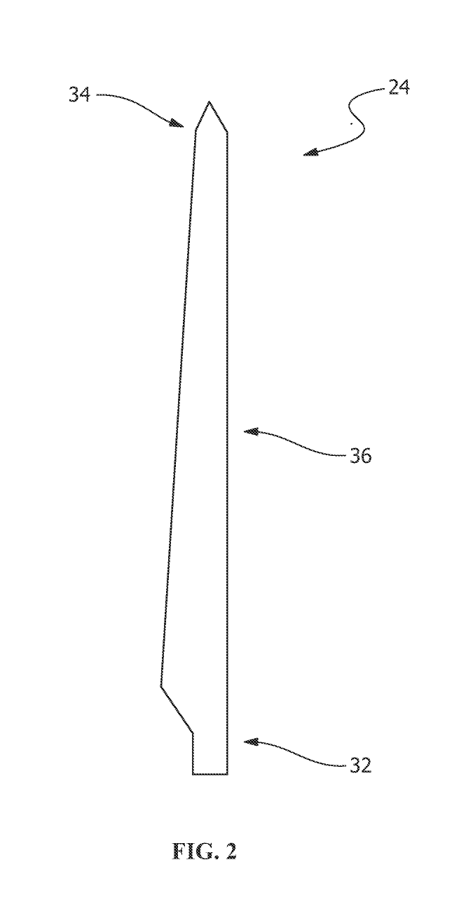

The basic configuration of a rotor blade 24 is shown in FIG. 2. Therein, rotor blade 24 includes a root section 32 used to mount rotor blade 24 to hub 22. Opposite to root section 32, a tip end 34 of rotor blade 24 is disposed. A body section 36 of rotor blade 24 extends between root section 32 and tip end 34.

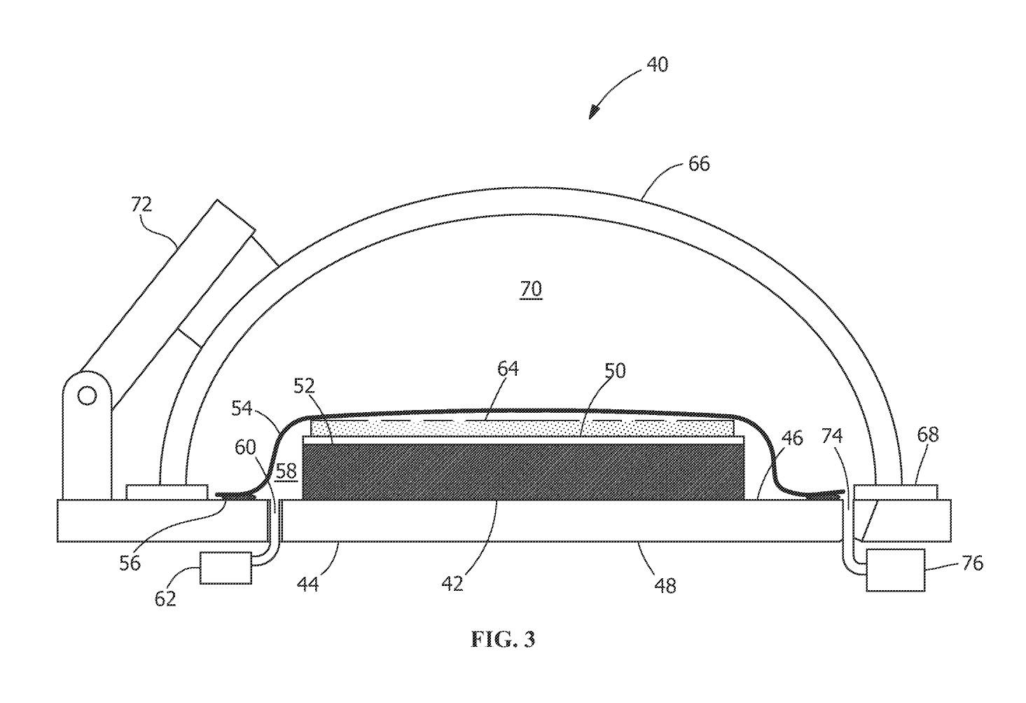

FIG. 3 is a sectional illustration of an exemplary embodiment of a processing apparatus 40 that may be used to remove air and volatiles from a pre-impregnated preform 42 to substantially eliminate voids from preform 42. Processing apparatus 40 also compacts the preform to form a fully compacted article that is ready for subsequent molding and curing. Processing apparatus 40 includes a base plate 44 having a top surface 46 and a bottom surface 48. Base plate 44 may also be referred to as a tool plate. Preform 42 is positioned on top surface 46 of base plate 44 for processing. An optional caul plate 50 is shown positioned on a top surface 52 of preform 42. As further shown in FIG. 3, a vacuum bag 54 encloses preform 42 and caul plate 50 (when used). Vacuum bag 54 is attached to base plate 44 with a seal 56 forming a first cavity 58. A vacuum port 60 extends through base plate 44 to communicatably connect first cavity 58 with a vacuum pump 62. In another embodiment, vacuum port 60 extends through vacuum bag 54. Vacuum bag 54 may include other materials or structures, for example, a layer of porous material 64 to conduct the vacuum throughout first cavity 58.

As shown in FIG. 3, a substantially rigid cover 66 encloses vacuum bag 54 and surrounds preform 42 and caul plate 50 (when used). Cover 66 is attached to base plate 44 with a seal 68 forming a second cavity 70. Optionally, cover 66 includes a pivotable device 72, such as a hinged arm that is secured at one end to cover 66 and secured to base plate 44 at another end of pivotable device. Pivotable device 72 can actuate between an open position that permits positioning or placement of preform 42, caul plate 50 (when used) and vacuum bag 54 enclosing preform 42 and caul plate 50 (forming first cavity 58), and a closed position (shown in FIG. 3) that defines second cavity 70 which encloses first cavity 58. A vacuum port 74 extends through base plate 44 to communicatably connect second cavity 70 with a vacuum pump 76. In another embodiment, vacuum port 74 extends through cover 66.

Preform 42 is formed from a plurality of reinforcing fibers and a polymer matrix by impregnating a web/mat of reinforcing fibers with a polymer. Any suitable reinforcing fiber can be used in preform 42. Examples of suitable reinforcing fibers include, but are not limited to, glass fibers, graphite fibers, carbon fibers, polymeric fibers, ceramic fibers, aramid fibers, kenaf fibers, jute fibers, flax fibers, hemp fibers, cellulosic fibers, sisal fibers, coir fibers and mixtures thereof. Any suitable polymer can be used to form preform 42, including thermosetting polymers and thermoplastic polymers. Examples of suitable thermosetting polymers include, but are not limited to, vinyl ester polymers, epoxy polymers, polyester polymers, polyurethane polymers, and mixtures thereof. Examples of thermoplastic polymers include, but are not limited to, polyolefins, polyamides, polyesters, polysulfones, polyethers, acrylics including methacrylic polymers, polystyrenes, polypropylenes, polyethylenes, polyphenelene sulfones, polyvinyl alcohol, and mixtures thereof

Base plate 44, cover 66 and caul plate 50 can be made from any suitable material, for example, any suitable metal, such as steel. Base plate 44, cover 66 and caul plate 50 can also be composed of any suitable material, for example, cover 66 can be composed of a suitable nonmetal, such as commercially available polyvinyl chloride round stock that is formed into a hemisphere, such as one half of a section of the round stock. Cover 66 can be constructed of non-circular segments, or even a closed geometry into which base plate 44, pre-impregnated preform 42 and vacuum bag 54 may be inserted, if desired, so long as the material and geometry can withstand the range of vacuum pressures. In other embodiments, any one of base plate 44 and caul plate 50 (when used) can be formed from other materials, for example, plastic materials, including fiber reinforced fibers. In an exemplary embodiment, base plate 44 is flat; however, in another embodiment, base plate 44 can have any suitable shape to produce a three dimensional preform 42. In a further embodiment, caul plate 50 may be flexible to facilitate forming shaped articles other than flat shaped preforms. A flexible caul plate 50 may be formed from a flexible plastic or rubber material, with or without fiber reinforcement.

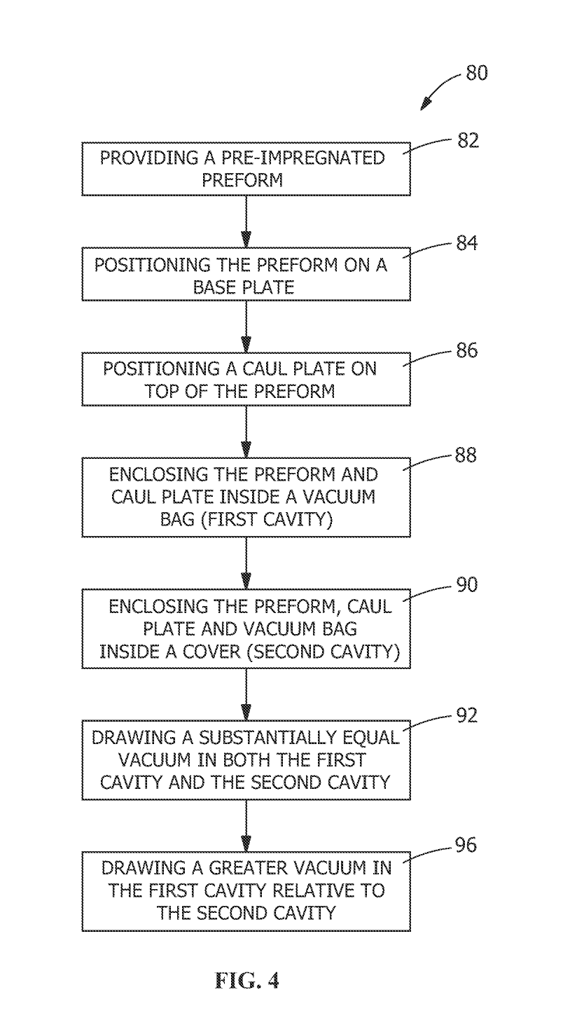

FIG. 4 is a flow chart of a method 80 of making a compacted composite material preform usable to make a composite material article, for example, rotor blade 24, shown in FIG. 2. FIG. 3 is one embodiment of a processing apparatus 40 from which method 80 can be practiced. Method 80 includes providing 82 a pre-impregnated preform formed from a plurality of reinforcing fibers and a polymer matrix, such as preform 42 (FIG. 3), and positioning 84 the preform on a base plate 44 (FIG. 3), optionally positioning 86 a caul plate 50 (FIG. 3) on top of the preform (if a caul plate is used). Method 80 also includes enclosing 88 preform 42 and caul plate 50 inside vacuum bag 54 (FIG. 3) which defines a first cavity 58 (FIG. 3). Further, method 80 includes enclosing 90 preform 42, caul plate 50 and vacuum bag 54 inside cover 66 (FIG. 3) which defines a second cavity 70 (FIG. 3). Method 80 further includes drawing 92 a vacuum in first cavity 58 (vacuum bag 54) through a vacuum port 60 to remove air and volatiles from the preform, while also drawing a vacuum in second cavity 70 (cover 66) through a vacuum port 74. The magnitudes of vacuum drawn between first cavity 58 (vacuum bag 54) and second cavity (cover 66) are substantially equal, in order for vacuum bag 54 to be in an equilibrium position that does not apply pressure to the preform, nor draw vacuum bag 54 sufficiently toward cover 66 such that seal 56 between vacuum bag 54 and base plate 44 (FIG. 3) is not compromised, while permitting evacuation of air from between the laminated layers of the preform. Method 80 still further includes drawing 96 a greater vacuum in first cavity 58 than in second cavity 70 such that vacuum bag 54 is urged into compressive contact with preform 42 to compact the plurality of reinforcing fibers and the polymer matrix, thereby resulting in a compacted composite material preform. The resultant compacted composite material preform can then moved to a shaped mold for final shaping and curing to form rotor blade 24. By compacting the composite material preform, the preform can more quickly and easily be cured in the shaped mold to form the composite material article.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of making a compacted composite material preform, comprising:
providing a pre-impregnated preform comprising a plurality of reinforcing fibers and a polymer matrix;
positioning the preform on a base plate;
enclosing the preform inside a vacuum bag defining a first cavity;
enclosing the preform and vacuum bag inside a substantially rigid cover defining a second cavity;
drawing a vacuum in the first cavity and the second cavity that is substantially equal or greater than the vacuum in the first cavity to remove air and volatiles from the preform; and
drawing a greater vacuum in the first cavity relative to the second cavity to urge the vacuum bag into compressive contact with the plurality of reinforcing fibers and the polymer matrix to a compacted arrangement.

2. The method of claim 1, further comprising positioning a caul plate on top of the preform.

3. The method of claim 1, wherein the method is conducted at a substantially constant temperature.

4. The method of claim 1, wherein the method is conducted without application of heat from the base plate.

5. The method of claim 1, wherein enclosing the preform inside the vacuum bag comprises enclosing the preform inside the vacuum bag by sealingly attaching the vacuum bag to the base plate.

6. The method of claim 1, wherein enclosing the preform and vacuum bag inside the cover comprises enclosing the preform inside and vacuum bag by sealingly attaching the cover to the base plate.

7. The method of claim 1, wherein the preform comprises a plurality of fibers selected from the group consisting of glass fibers, graphite fibers, carbon fibers, polymeric fibers, ceramic fibers, aramid fibers, kenaf fibers, jute fibers, flax fibers, hemp fibers, cellulosic fibers, sisal fibers, coir fibers and mixtures thereof

8. The method of claim 1, wherein the cover includes a pivotable device movable between an open position for positioning the preform and a closed position for enclosing the preform and vacuum bag inside the cover.
